(19) United States
(12) Patent Application Publication
(10) Pub. No.: US 2004/0104586 A1
(43) Pub. Date: Jun. 3, 2004

(54) Food utensil

(76) Inventor: Sarah R. Rose, San Carlos, CA (US)

Correspondence Address: Sarah R. Rose, 411 Hillcrest Road, San Carlos, CA, 94070, US

(21) Appl. No.: 10/308,744

(22) Filed: Dec. 3, 2002

(51) Int. Cl. A47G 21/10; A47J 43/28

(52) U.S. Cl. 294/16; 294/99.2

(57) ABSTRACT

The present invention describes a utensil for retrieving contents from a container.

### FIELD OF THE INVENTION

The present invention pertains to the field of food implements. More particularly, the present invention relates to a food utensil for retrieving contents from containers.

### BACKGROUND OF THE INVENTION

In food preparation there is often the need to retrieve contents from a container. One method of retrieving contents is to empty the container either partially or wholly by, for example, opening a lid and pouring out or emptying the entire contents. The problem with this approach is that the entire contents may not be desired. Additionally, the contents may consist of liquids that may be difficult to return to the container while maintaining a sanitary condition. Other methods for retrieval of contents that are somewhat solid or rigid are to spear or scoop the contents and remove them. This has the advantage of not necessitating the return of fluids to the container. Still the spearing method is destructive of the food and certainly may affect the appearance of the resulting retrieved contents. Likewise, the scoop may be difficult to maneuver into the container, may to difficult to get under the food, and may spill part of the retrieved food upon removal.

### SUMMARY OF THE INVENTION

An improved food utensil for retrieval of food contents is disclosed. The utensil allows easy entry into a container and facilitates acquisition of contents. The utensil may also have contours to assist in supporting, aligning, and retrieving the contents. Because of the features of the utensil, it may be possible to reduce the total damage to the contents retrieved and contents remaining.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a top view of one embodiment of the utensil;

FIG. 2 is a side view of one of the members in FIG. 1;

FIGS. 3, 4, 5, 6, 7, and 8 are embodiments of a grasping member;

FIG. 9 is an embodiment of a manually engaged member;

FIG. 10 is another embodiment of a grasping member mechanism; and

FIGS. 11 and 12 are embodiments of the utensil.

### DETAILED DESCRIPTION

An improved utensil for retrieving items is described. The utensil mechanism allows for easy access to items. The utensil may also have contours to assist in supporting, aligning, and retrieving items. Because of the features of the utensil, it may be possible to reduce the total damage to items retrieved and/or items remaining.

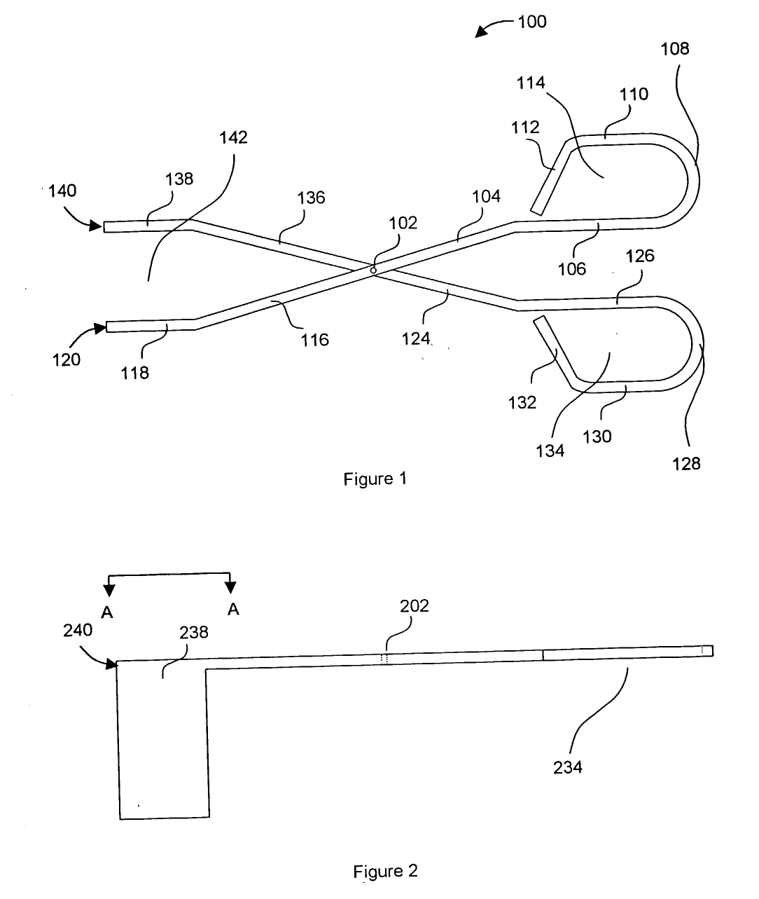

FIG. 1 illustrates a top view of the utensil 100 for one embodiment. In FIG. 1, the utensil 100 has two members 120 and 140 that are substantially similar in shape (when viewed from the top) and hingedly attached in scissors-like manner at 102. Member 120 comprises segments 118, 116, 104, 106, 108, 110, and 112. Member 140 comprises segments 138, 136, 124, 126, 128, 130, and 132. In this embodiment, the utensil 100 is envisioned as being operated by a human using fingers and/or a thumb. In this embodiment, for example, a person's thumb may reside in the region 134, and a finger in region 114. Thus segments 106, 108, 110, and 112, and the corresponding segments 126, 128; 130, and 132 are formed in such a manner and dimensions as to fit and be suitable for operation by a human thumb and/or fingers. Region 142 is where an item to be retrieved would be located and grasped by segments 118 and 138. Thus, for example, in this embodiment, where fingers and/or a thumb are located in regions 114 and 134, and a person drawing their fingers and/or thumb together would apply a force to segments 106 and 126 which because of the stiffness of the members 120 and 140 and the hinged attachment of the members 120 and 140 at hinge 102, would result in a force against an item located in region 142 by segments 118 and 138 being drawn toward each other. Thus, segments 118 and 138 would grasp an item in the region 142. Conversely, in this example, a person moving their fingers and/or thumb away from each other would relieve any grasping force on an item located in region 142. Such a utensil may be used to retrieve such items as pickles, olives, canned peaches, cherries, etc.

FIG. 2 is a side view of one of the members in FIG. 1. In this side view of member 240, segment 238 shows a large grasping surface. Additionally, shown in this side view is a pivot point 202, and the region 234 where a person's finger or thumb would be positioned through the member 240. Segment 238 in this embodiment is shown as a flat rectangular surface. Alternate embodiments of segment 238 may include, but are not limited to a curved surface, an irregular surface shape, an oval shape, a circular shape, a shape with a lip at an edge, tines, etc. Additionally, the surface may be, but is not limited to, a dimpled surface, a ribbed surface, a surface with holes, slots, etc. An embodiment with a curved surface may provide more contact with the item to be retrieved and thus exert less pressure in a given area thereby possibly reducing pressure induced damage. Such a curved surface may, for example, assist in the retrieval of whole pickles from ajar. A surface having holes, slots, or other openings may allow for the retrieval of an item in a fluid with minimal fluid retrieved by allowing the fluid to pass through the openings. Thus, for example, a curved surface with openings may allow for the retrieval of pickles from a jar containing pickles and juice with a minimum of fluid from ajar being removed.

While the materials for the utensil have not been discussed in detail, one knowledgeable in the art will understand that the utensil may be made of, for example, stainless steel, plastic, resins, polymers, wood, ferrous materials, non-ferrous materials, non-stick surfaces like Teflon, or a combination of materials, etc., depending upon the properties desired for hygienic cleaning and handling. For example, for common household use the material may be made of a dishwasher safe material. A commercial environment may require a stainless steel version for steam cleaning purposes. Similarly, the segments of the utensil that come in contact with the human body may be coated and/or constructed of a thermally insulating material so that if used to grasp hot items, for example, a cooked hot dog the heat will not be as readily transferred to the human body part in contact with the utensil. A thermally insulating material, may include, but is not limited to, for example, wood, plastic, Plexiglas, a rubberized coating, Delrin, etc.

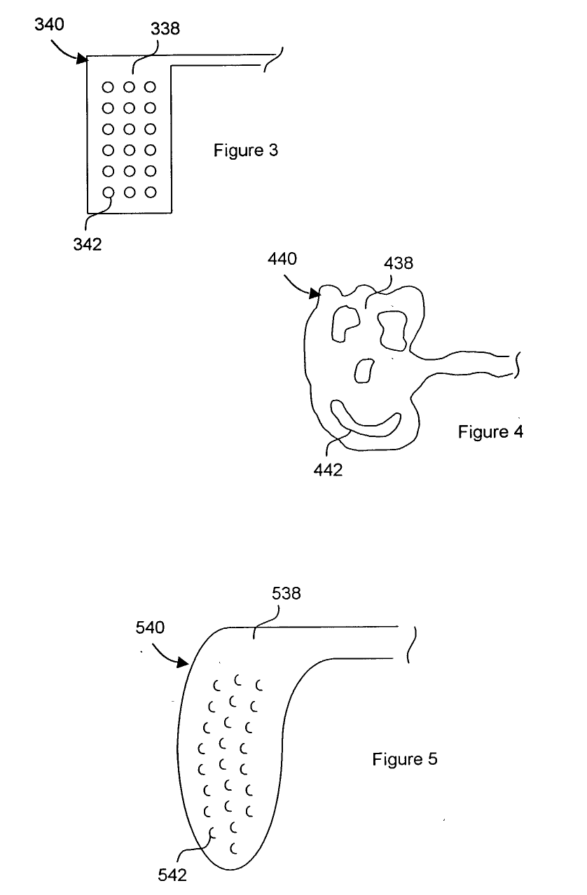

FIG. 3 is an embodiment of a member 340, having a grasping surface 338, which has a series of holes 342. The holes 342 may allow for contents retrieved from a liquid to let the liquid drain away before the contents are fully removed from the container.

FIG. 4 is an embodiment of a member 440, having a grasping surface 438 which is irregular in shape and which has a series of openings 442 irregular in shape.

FIG. 5 is an embodiment of a member 540, having a grasping surface 338 which has a series of dimples 542. The dimples 542 may assist in gripping the contents to be removed.

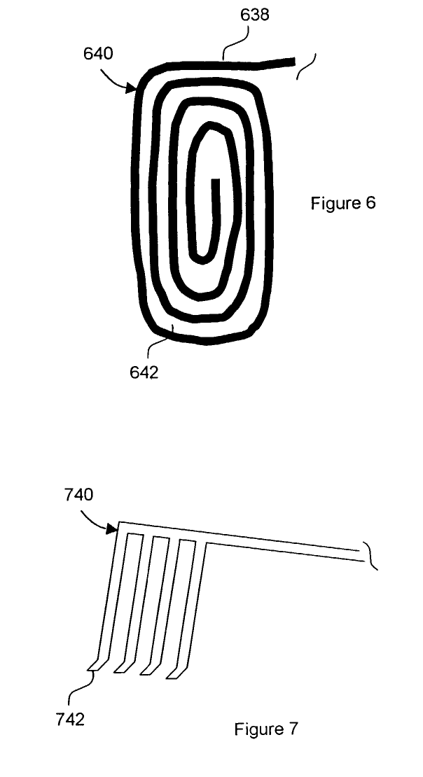

FIG. 6 is an embodiment of a member 640, having a grasping surface 638 formed as a spiral-type pattern with gaps 642 for allowing drainage.

FIG. 7 is an embodiment of a member 740, having a grasping surface 742 formed as tines.

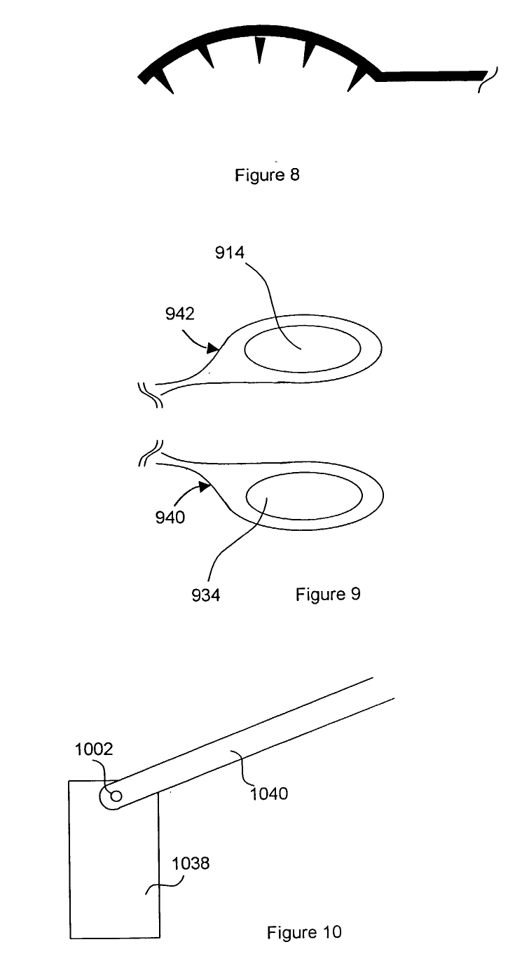

FIG. 8 is a section view (A-A) from FIG. 2 of an embodiment of a curved grasping member having spikes.

FIG. 9 is another embodiment of a utensil having two members 940 and 942 formed in such a fashion as to be operable by a human using fingers and/or a thumb. In this embodiment, for example, a person's thumb may reside in the region 934, and a finger in region 914.

FIG. 10 is a embodiment in which the grasping surface 1038 is pivotally attached 1002 to a leveraging member 1040, that may be operated, for example, by a human thumb and finger. The pivoting of the grasping surface allows the user to enter, for example, a food container at a variety of angles and allows for more freedom in grasping contents. The pivot may be freely moveable, kept at a particular angle by friction or some engaging or locking mechanism, or may become relatively fixed in position once a grasping force is applied to the grasping surface 1038.

Note that while the grasping surface 1038 is shown as a rectangular grasping surface, other embodiments are possible, for example the grasping surfaces of FIGS. 3-8 may be pivotally attached to member 1040

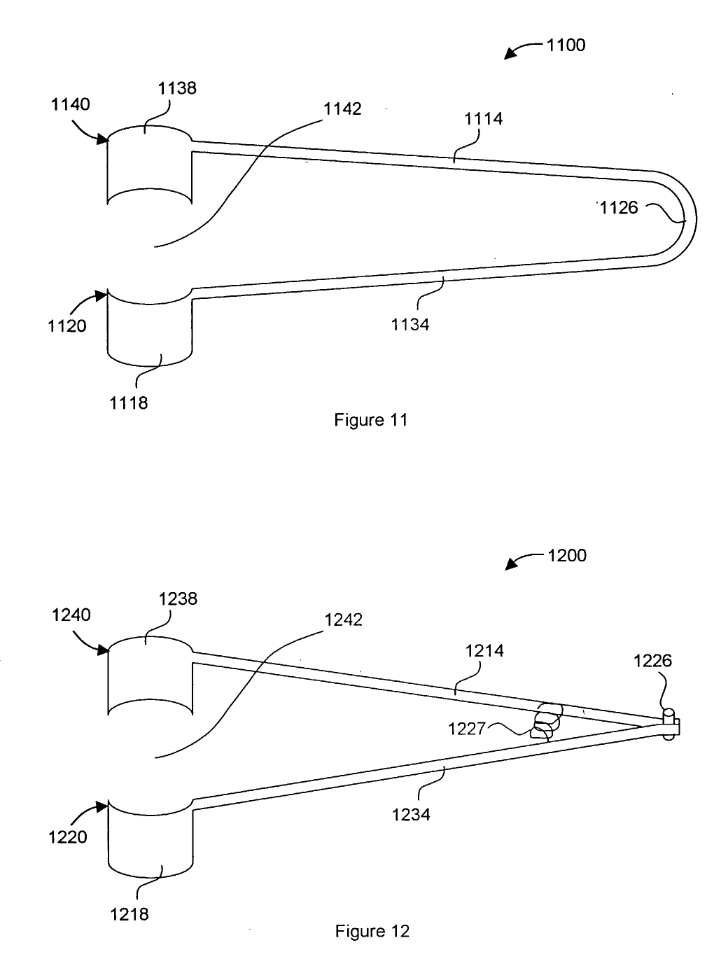

FIG. 11 shows an embodiment in which the utensil 1100 is formed without a hinge point for the manually operated segment. Members 1120 and 1140 may be comprised of, for example, a singlely formed material, comprising food grasping surfaces 1118 and 1138 and tong-like members 1114 and 1134 connected to a spring-like material 1126. In this embodiment, the utensil 1100 is envisioned as being operated by a human using fingers and a thumb. In this embodiment, for example, a person's thumb may reside in the region 1134, and fingers in region 1114. Grasping surfaces 1118 and 1138, in this embodiment are curved to assist in retrieving contents when pressure is applied to members 1114 and 1134, thereby bringing the grasping surfaces 1118 and 1138 in contact with an item to be retrieved from the region 1142. Note that the grasping surfaces 1138 and 1118 may or may not be pivotally connected to the tong-like members 1114 and 1134. Additionally, for repeated use, it is envisioned that the spring-like material 1126 may be operated within Youngs modulus of elasticity.

FIG. 12 shows an embodiment in which the utensil 1200 is formed with a hinge point 1226 at an end opposite to the food grasping surfaces 1218 and 1228 for retrieving contents in the region 1242. Members 1220 and 1240 are comprised of the members 1214 and 1234 connected to a spring 1227. For repeated use, it is envisioned that the spring 1227 may be operated within Youngs modulus of elasticity.

Thus, what has been described above is a utensil mechanism which provides for easy access to, and removal of, contents, while at the same time providing integrated support and alignment for retrieval. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A utensil for retrieving contents from a container having a manually operable distal end connected via a first member to a pivotally hinged joint, said pivotally hinged joint connected via a second member to a content grasping proximal end.

2. The apparatus according to claim 1, wherein the manually operable distal end comprises a plurality of opposing manually operable holding means.

3. The apparatus according to claim 2, wherein the opposing manually operable holding means are operable by a thumb and a finger on a hand.

4. The apparatus according to claim 1, wherein the manually operable distal end further comprises a thermally different material from the content grasping proximal end.

5. The apparatus according to claim 1, wherein said content grasping proximal end comprises a plurality of opposing clamping surfaces.

6. The apparatus according to claim 1, wherein said content grasping proximal end comprises a textured surface selected from the group consisting of smooth, dimpled, protrusions, perforated, slotted, spiral, and curved.

7. An apparatus comprising:
two opposing movable members;
a tong-like member connected to the two opposing movable members; and
opposing grasping members connected to the two opposing movable members.

8. The apparatus of claim 7 wherein the opposing grasping members are pivotally connected to the two opposing movable members.

9. The apparatus of claim 8 wherein the opposing grasping members are two and substantially the same size.

10. The apparatus of claim 9 wherein the opposing grasping members comprise textured surfaces selected from the group consisting of smooth, dimpled, protrusions, perforated, slotted, spiral, and curved.

11. The apparatus according to claim 7, wherein the tong-like member connected to the two opposing movable members is operable within Youngs modulus of elasticity.

12. The apparatus according to claim 7 wherein the two opposing movable members are substantially coplanar.

13. The apparatus according to claim 7 wherein the two opposing movable members are a thermally insulating material.

14. The apparatus according to claim 7 wherein the two opposing movable members are operated by a thumb and a finger.

15. A food utensil for extracting pickles from a container, the utensil comprising:
means for human operable proximal end; and
means for grasping a pickle at a distal end.

16. The apparatus of claim 15 wherein the distal end is insertable into a container of food while the proximal end is outside the container of food.

17. The apparatus of claim 15 wherein the means for grasping a pickle at a distal end further comprises a pivotal means for grasping.

18. The apparatus of claim 15 wherein the means for human operable proximal end further comprises a means for thermally reducing conductive heat transfer to a human.

19. An apparatus for extracting contents from a container comprising:
a grasping structure;
a support member coupled to the grasping structure; and
a region of the support structure suitable for grasping by a human.

20. The apparatus of claim 19 wherein the grasping structure comprises a plurality of opposing surfaces.
